(19) United States
(12) Patent Application Publication
(10) Pub. No.: US 2023/0037461 A1
(43) Pub. Date: Feb. 9, 2023

(54) CASE FOR A CELLULAR PHONE CONFIGURED TO ENABLE THE CELLULAR PHONE TO CAPTURE 360-DEGREE FIELD-OF-VIEW IMAGES

(71) Applicant: Sam Salemnia, Los Angeles, CA (US)

(72) Inventor: Sam Salemnia, Los Angeles, CA (US)

(21) Appl. No.: 17/882,807

(22) Filed: Aug. 8, 2022

Related U.S. Application Data
(60) Provisional application No. 63/231,170, filed on Aug. 9, 2021.

(51) Int. Cl. H04N 5/247; H04N 5/232; H04N 5/225; H04B 1/3888; A45C 11/00

(52) U.S. Cl. CPC H04N 5/247; H04N 5/23238; H04N 5/2252; H04N 5/2257; H04B 1/3888; A45C 11/00; A45C 2011/002

(57) ABSTRACT

A case for a smart phone configured to enable the smart phone to capture 360-degree field-of-view images and videos. The case includes a back face, an upper wall extending from an upper portion of the back face, a lower wall extending from a lower portion of the back face, a first sidewall extending from a first side portion of the back face, a second sidewall extending from a second side portion of the back face, a first camera, and a second camera. The back face, the upper wall, the lower wall, the first sidewall, and the second sidewall define a chamber configured to accommodate the smart phone.

### CROSS-REFERENCE TO RELATED APPLICATION(S)

The present application claims priority to and the benefit of U.S. Provisional Application No. 63/231,170, filed on Aug. 9, 2021, the entire content of which is incorporated herein by reference.

### BACKGROUND

### 1. Field

The present disclosure relates generally to a case configured to enable a cellular phone to capture 360-degree field-of-view images.

### 2. Description of Related Art

Smart phones commonly include a rear-facing camera and a front-facing camera. The rear-facing camera is commonly utilized to take photographs and videos of other individuals and/or of a scene not including the individual taking the photo or video. The front-facing camera is commonly utilized to take photographs and videos of the individual taking the photograph or video.

Smart phones may also be configured to take panoramic photographs by prompting the user to move the phone in a specified manner (e.g., angling the phone from left to right at a particular speed). However, conventional smart phones are not configured to take 360-degree field-of-view photographs or videos. Some conventional methods of taking 360-degree photographs or videos include a software application configured to activate the smart phone's vibration feature in a manner that causes the smart phone to rotate when the smart phone is placed upright on a smooth surface. Other conventional mechanisms include a rotating pedestal or platform on which the smart phone can be placed to generate 360-degree photographs and videos. However, these conventional methods are slow and cumbersome and may require specialized hardware. Additionally, because these conventional methods physically rotate the smart phone, they do not capture images from all angles simultaneously (i.e., the images are captured sequentially as the smart phone rotates), and therefore the resultant photograph or video is not temporally consistent.

### SUMMARY

The present disclosure relates to various embodiments of a case for a smart phone configured to enable the smart phone to capture 360-degree field-of-view images and videos. In one embodiment, the case includes a back face, an upper wall extending from an upper portion of the back face, a lower wall extending from a lower portion of the back face, a first sidewall extending from a first side portion of the back face, a second sidewall extending from a second side portion of the back face, a first camera, and a second camera. The back face, the upper wall, the lower wall, the first sidewall, and the second sidewall define a chamber configured to accommodate the smart phone.

The first camera may be along the first sidewall, and the second camera may be along the second sidewall.

Each of the first camera and the second camera may be proximate to the upper wall.

The first camera may be along the upper wall, and the second camera may be along the lower wall.

The case may also include a connector configured to connect to a port of the smart phone, and each of the first camera and the second camera may be electrically coupled to the connector.

The connector may extend inward from the lower wall of the case.

Each of the first camera and the second camera may include a lens, a sensor, and an image signal processor.

The first camera and/or the second camera may be a night vision camera.

The case may also include a clip on the back face of the case configured to connect to a selfie-stick.

The case may also include opening in the back face configured to accommodate a rear-facing camera of the smart phone.

The first camera may be configured to capture images in a first direction, and the second camera may be configured to capture images in a second direction opposite the first direction.

The present disclosure also relates to various method of generating a 360-degree image from a smart phone and a case accommodating the smart phone. In one embodiment, the method includes receiving at least one first image captured by a rear-facing camera of the smart phone, receiving at least one second image captured by a front-facing camera of the smart phone, receiving at least one third image captured by a first camera on the case, receiving at least one fourth image captured by a second camera on the case, and integrating the at least one first image, the at least one second image, the at least one third image, and the at least one fourth image into the 360-degree image.

The first camera may be along a first sidewall of the case, and the second camera may be along a second sidewall of the case.

Each of the first camera and the second camera may be proximate to an upper wall of the case.

The first camera may be along an upper wall of the case, and the second camera may be along a lower wall of the case.

The first image may be captured in a first direction, and the second image may be captured in a second direction opposite the first direction.

Third image may be captured in a third direction orthogonal to each of the first direction and the second direction, and the fourth image may be captured in a fourth direction opposite the third direction.

Each of the first image, the second image, the third image, and the fourth image include a photograph.

Each of the first image, the second image, the third image, and the fourth image include a video.

The method may also include simultaneously capturing the first image from the rear-facing camera of the smart phone, the second image from the front-facing camera of the smart phone, the third image from the first camera on the case, and the fourth image from the second camera on the case.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable device or method.

### BRIEF DESCRIPTION OF THE DRAWINGS

The accompanying drawings, together with the specification, illustrate exemplary embodiments of the present disclosure, and, together with the description, serve to explain the principles of the present disclosure. The drawings are not necessarily drawn to scale.

FIGS. 1A-1E are back view, a front view, a left-side view, a right-side view, and a bottom view, respectively, of a case according to one embodiment of the present disclosure on a smart phone; and

FIG. 2 is a flowchart illustrating tasks of a method of capturing 360-degree field-of-view images from a smart phone in a case having a pair of cameras.

### DETAILED DESCRIPTION

The present disclosure relates to various embodiments of a case for a smart phone. The case includes a first camera and a second camera. The images (photograph(s) and/or video) captured by the first and second cameras of the case are integrated with images captured by the rear-facing camera and the front-facing camera of the smart phone to create a 360-degree field-of-view photograph or video. The present disclosure also relates to various embodiments of a method of integrating images (photograph(s) and/or video) captured by a first camera and a second camera of a case with images (photograph(s) and/or video) captured by a rear-facing camera and a front-facing camera of the smart phone to create a 360-degree field-of-view photograph or video. Accordingly, the embodiments of the case and the method of the present disclosure enable creating 360-degree field-of-view photographs and videos without rotating the smart phone. Additionally, in one or more embodiments, the images may be captured simultaneously or substantially simultaneously by the first and second cameras of the case and the front- and rear-facing cameras of the smart phone to enable the creation of temporally consistent 360-degree field-of-view photographs and videos.

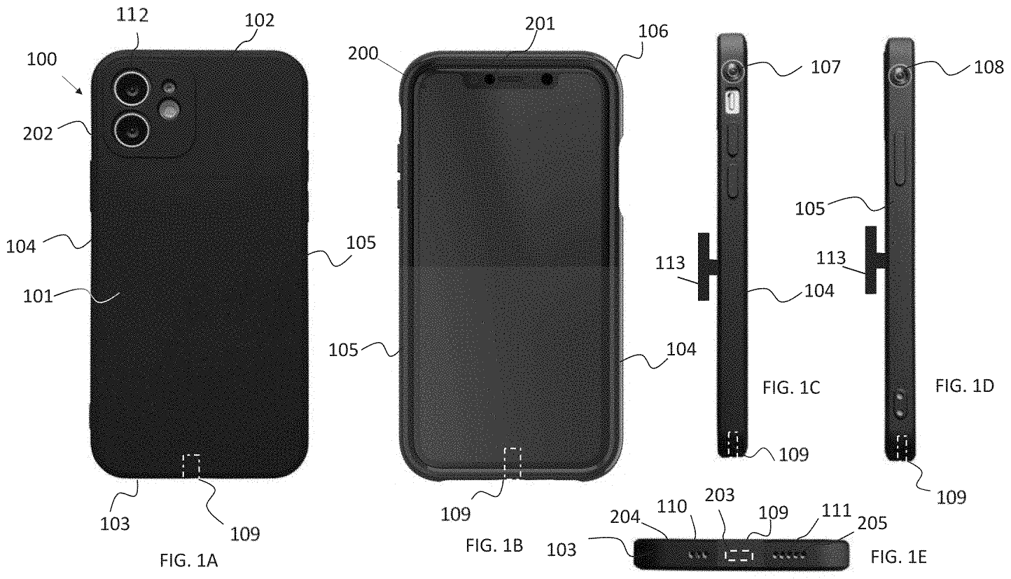

With reference now to the embodiment illustrated in FIGS. 1A-1E, the case 100 includes a back face 101, an upper wall 102 extending from an upper portion of the back face 101, a lower wall 103 extending from a lower portion of the back face 101 and parallel (or substantially parallel to) the upper wall 102, a first sidewall 104 extending from a first side portion of the back face 101, and a second sidewall 105 extending from a second side portion of the back face 101 and parallel (or substantially parallel to) the first sidewall 104. The first sidewall 104 extends from one end of the upper wall 102 to one end of the lower wall 103. The second sidewall 105 extends from the other end of the upper wall 102 to the other end of the lower wall 103. In the illustrated embodiment, the upper wall 102, the lower wall 103, the first sidewall 104, and the second sidewall 105 extend around a periphery of the back face 101. Additionally, in the illustrated embodiment, the upper wall 102, the lower wall 103, the first sidewall 104, and the second sidewall 105 define a chamber 106 configured to accommodate a smart phone 200. In the illustrated embodiment, the case 100 also includes rounded corners 106 between adjacent walls 102, 103, 104, 105. In one or more embodiments, the upper wall 102, the lower wall 103, and the first and second sidewalls 104, 105 may have any other configuration (e.g., size and shape) depending on or corresponding to the configuration of the smart phone 200.

In the illustrated embodiment, the case 100 also includes a first camera 107 along the first sidewall 104, and a second camera 108 along the second sidewall 105. The position of the first camera 107 on the first sidewall 104 may correspond or substantially correspond to the position of the second camera 108 on the second sidewall 105. That is, in one or more embodiments, the first and second cameras 107, 108 may be aligned or substantially aligned along a horizontal line. In one or more embodiments, the first and second cameras 107, 108 on the sidewalls 104, 105, respectively, of the case 100 may be located proximate to the upper wall 102 of the case 100 such that the first and second cameras 107, 108 are located proximate to the front- and rear-facing cameras 201, 202 of the smart phone 200. Although in the illustrated embodiment the first and second cameras 107, 108 are provided on the first and second sidewalls 104, 105 of the case 100, in one or more embodiments, the first and second cameras 107, 108 may be provided on the upper and lower walls 102, 103, respectively, of the case 100. Furthermore, although in the illustrated embodiment the case 100 includes two cameras 107 and 108, in one or more embodiments, the case 100 may include a single camera (e.g., a camera on the upper wall 102, the lower wall 103, or one of the sidewalls 104, 105) depending on the desired field-of-view. In one or more embodiments, the case 100 may include more than two cameras 107 and 108 (e.g., the case 100 may include three or more cameras). For instance, in one or more embodiments, the case 100 may include one or more cameras on each of the upper wall 102, the lower wall 103, the first sidewall 104, and the second sidewall 105.

In the illustrated embodiment, the first and second cameras 107, 108 are oriented in opposite (or substantially opposite) directions (i.e., the first and second cameras 107, 108 are oriented 180 degrees or approximately 180 degrees from each other). When the case 100 is attached to a smart phone 200 having a front-facing camera 201 and a rear-facing camera 202, the first camera 107 of the case 100 is configured to capture images from a first quadrant of approximately 90 degrees, the rear-facing camera 202 of the smart phone 200 is configured to capture images from a second quadrant of approximately 90 degrees, the second camera 108 of the case 100 is configured to capture images from a third quadrant of approximately 90 degrees, and the front-facing camera 201 of the smart phone 200 is configured to capture images from a fourth quadrant of approximately 90 degrees. Accordingly, together, the cameras 107, 108, 201, 202 of the case 100 and the smart phone 200 are configured to capture 360-degree (or approximately 360-degree) field-of-view images.

In the illustrated embodiment, the case 100 also includes a connector 109 (e.g., a Lightning™ connector or a USB connector, such as micro-USB, USB type A, B, or C, or USB mini connector) configured to plug into a port 203 (e.g., a female port, such as a Lightning™ port, a micro-USB port, a USB type A, B, or C port, or a USB mini port) in the smart phone 200. Accordingly, in one or more embodiments, the cameras 107, 108 may be powered by the secondary battery (i.e., the rechargeable battery) of the smart phone 200, and software stored in a non-volatile memory device of the smart phone 200 (or accessible by the smart phone 200, such as on the “cloud”) may be utilized to capture photograph(s) and/or video from the first and second cameras 107, 108 of the case 100 and to integrate the photograph(s) and/or video captured by the first and second cameras 107, 108 of the case 100 with photograph(s) and/or video captured by the front- and rear-facing cameras 201, 202 of the smart phone 200 to generate a 360-degree field-of-view photograph or video (e.g., the smart phone 200 includes software instructions configured to stitch the photographs or videos together into a 360-degree field-of-view photograph or video). In one or more embodiments, the case 100 may include one or more secondary batteries (i.e., one or more rechargeable batteries) separate from the battery in the smart phone 200. The one or more secondary batteries in the case 200 may be utilized to power the cameras 107, 108 on the case 100 and/or to augment or supplement the power supplied by the secondary battery of the smart phone 200 (i.e., the secondary battery of the case 200 may function as a back-up power supply for the smart phone 200).

In one or more embodiments, the first and second cameras 107, 108 may each include a sensor, a lens configured to focus incoming light on the sensor, and an image signal processor (ISP) configured to convert an image signal from the sensor into a viewable image. In one or more embodiments, each of the first and second cameras 107, 108 may include a wide- or ultra-wide lens (e.g., a focal length of 25 mm or less, such as a focal length of 13 mm). Each of the first and second cameras 107, 108 also includes a wire (e.g., a ribbon cable) connecting the ISP to the connector 109. In one or more embodiments, one or both of the first and second cameras 107, 108 may include a flash and/or a light. In one or more embodiments, one or both the of the first and second cameras 107, 108 may be provided without a flash or a light. Additionally, in one or more embodiments, one or both of the first and second cameras 107, 108 may be configured to capture night vision images (e.g., one or both of the first and second cameras 107, 108 may include an infrared light). That is, in one or more embodiments, one or both of the first and second cameras 107, 108 may be an infrared or thermal imaging camera (i.e., a night vision camera).

In the illustrated embodiment, the lower wall 103 of the case 100 includes at least one opening 110 corresponding to a speaker 204 of the smart phone 200, and at least one opening 111 corresponding to a microphone 205 of the smart phone 200. Additionally, in the illustrated embodiment, the case 100 includes an opening 112 in the back face 101 configured to accommodate the rear-facing camera 202 of the smart phone 202.

Additionally, in one or more embodiments, the case 100 may include a clip or connector 113 on an outer surface of the back face 101 that is configured to be connected to a selfie-stick (e.g., a gimbal stabilized selfie-stick).

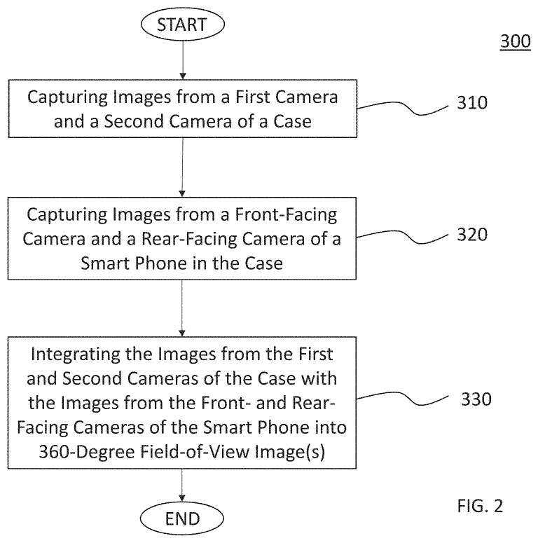

FIG. 2 is a flowchart illustrating tasks of a method 300 of capturing 360-degree field-of-view images (e.g., photographs and/or video) from a smart phone in a case having a pair of cameras. In the illustrated embodiment, the method 300 includes a task 310 of capturing images (e.g., still photographs or video images) from a first camera and a second camera of the case. In one or more embodiments, the images captured in task # may be opposing views of a scene (180-degree opposed views). In one or more embodiments, the first and second cameras may be provided along opposing sidewalls of the case, or along upper and lower walls of the case.

The method 300 also includes a task 320 of capturing images (still photographs or video images) from a rear-facing camera and a front-facing camera of the smart phone i the case utilized to capture the images in task 310. In one or more embodiments, the front- and rear-facing cameras of the smart phone may be oriented in opposing directions, and may be oriented orthogonal or substantially orthogonal to the directions in which the first and second cameras of the case are oriented.

In the illustrated embodiment, the method 300 also includes a task 330 of integrating the images captured from the first and second cameras of the case in task 310 with the images captured from the front- and rear-facing cameras of the smart phone in task 320 into a 360-degree field-of-view image or video. In this manner, 360-degree field-of-view images (e.g., 360-degree field-of-view still images or 360-degree field-of-view video) may be capture without having to move, rotate, or otherwise manipulate the smart phone. Additionally, in one or more embodiments, the task 320 of capturing the images from the front- and rear-facing cameras of the smart phone may be performed simultaneously or substantially simultaneously with the task 310 of capturing the images from the first and second cameras of the case. Simultaneously or substantially simultaneously capturing the images from the first and second cameras of the case and the front- and rear-facing cameras of the smart phone enables the creation of temporally consistent 360-degree field-of-view photographs and videos in task 330.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described systems and methods of operation can be practiced without meaningfully departing from the principles, spirit, and scope of this invention, as set forth in the following claims, and equivalents thereof.

What is claimed is:

1. A case for a smart phone configured to enable the smart phone to capture 360-degree field-of-view images and videos, the case comprising:
a back face;
an upper wall extending from an upper portion of the back face;
a lower wall extending from a lower portion of the back face;
a first sidewall extending from a first side portion of the back face;
a second sidewall extending from a second side portion of the back face;
a first camera; and
a second camera,
wherein the back face, the upper wall, the lower wall, the first sidewall, and the second sidewall define a chamber configured to accommodate the smart phone.

2. The case of claim 1, wherein the first camera is along the first sidewall, and wherein the second camera is along the second sidewall.

3. The case of claim 2, wherein each of the first camera and the second camera is proximate to the upper wall.

4. The case of claim 1, wherein the first camera is along the upper wall, and wherein the second camera is along the lower wall.

5. The case of claim 1, further comprising a connector configured to connect to a port of the smart phone, wherein each of the first camera and the second camera is electrically coupled to the connector.

6. The case of claim 5, wherein the connector extends inward from the lower wall of the case.

7. The case of claim 1, wherein each of the first camera and the second camera comprises:
a lens;
a sensor; and
an image signal processor.

8. The case of claim 1, wherein at least one of the first camera and the second camera is a night vision camera.

9. The case of claim 1, further comprising a clip on the back face of the case configured to connect to a selfie-stick.

10. The case of claim 1, further comprising an opening in the back face configured to accommodate a rear-facing camera of the smart phone.

11. The case of claim 1, wherein the first camera is configured to capture images in a first direction, and wherein the second camera is configured to capture images in a second direction opposite the first direction.

12. A method of generating a 360-degree image from a smart phone and a case accommodating the smart phone, the method comprising:
receiving at least one first image captured by a rear-facing camera of the smart phone;
receiving at least one second image captured by a front-facing camera of the smart phone;
receiving at least one third image captured by a first camera on the case;
receiving at least one fourth image captured by a second camera on the case; and
integrating the at least one first image, the at least one second image, the at least one third image, and the at least one fourth image into the 360-degree image.

13. The method of claim 12, wherein the first camera is along a first sidewall of the case, and wherein the second camera is along a second sidewall of the case.

14. The method of claim 13, wherein each of the first camera and the second camera is proximate to an upper wall of the case.

15. The method of claim 12, wherein the first camera is along an upper wall of the case, and wherein the second camera is along a lower wall of the case.

16. The method of claim 12, wherein the at least one first image is captured in a first direction, and wherein the at least one second image is captured in a second direction opposite the first direction.

17. The method of claim 16, wherein the at least one third image is captured in a third direction orthogonal to each of the first direction and the second direction, and wherein the at least one fourth image is captured in a fourth direction opposite the third direction.

18. The method of claim 12, wherein each of the at least one first image, the at least one second image, the at least one third image, and the at least one fourth image comprise a photograph.

19. The method of claim 12, wherein each of the at least one first image, the at least one second image, the at least one third image, and the at least one fourth image comprise a video.

20. The method of claim 12, further comprising simultaneously capturing the at least one first image from the rear-facing camera of the smart phone, the at least one second image from the front-facing camera of the smart phone, the at least one third image from the first camera on the case, and the at least one fourth image from the second camera on the case.
